(19) United States
(12) Patent Application Publication
(10) Pub. No.: US 2009/0198703 A1
(43) Pub. Date: Aug. 6, 2009

(54) INTELLIGENT DATA STORAGE SYSTEM

(75) Inventors: Ahmed Ezzat, Cupertino, CA (US); Dinkar Sitaram, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 12/205,445

(22) Filed: Sep. 5, 2008

Related U.S. Application Data
(60) Provisional application No. 61/025,154, filed on Jan. 31, 2008.

(51) Int. Cl. G06F 17/30

(52) U.S. Cl. 707/10; 707/E17.032

(57) ABSTRACT

An intelligent data storage system, comprising: one or more intelligent storage devices each comprising one or more processors, a memory, and a storage medium configured to store source data; and one or more application hosts each comprising one or more processors and a memory, communicatively coupled to said one or more intelligent storage devices and configured to generate an execution plan, comprising at least one data filtering parameter, to divide said execution plan into one or more fragments comprising said at least one data filtering parameter, and to provide said one or more fragment to said one or more intelligent storage devices, wherein said intelligent storage device is configured to execute said execution plan fragment on the source data to generate result data selected from the source data based on said at least one data filtering parameter.

### BACKGROUND

1. Field of the Invention

The present invention relates generally to data storage systems, and more particularly, to an intelligent data storage system

2. Related Art

In the field of computer data storage systems, many different types of data are stored in various formats. For example, text files may be used to store text such as emails, HTML code, word processing documents, and other text-based information. Also, for example, databases which may be used to store a large amount of information, often divided up into various categories, may be stored in computer data storage systems. These and other types of data may be stored on storage mediums, such as a magnetic hard disk, and later accessed by search programs or computer applications. Depending on the size of the data files being searched or the amount of data retrieved, the search program or application accessing the stored data may receive a voluminous amount of data. This large amount of data may significantly strain or even exceed the computational capabilities of the memory and/or processors available to the search program or computer application, and cause various negative effects in the data storage system

### SUMMARY

According to one aspect of the present invention, there is provided an intelligent data storage system comprising: one or more intelligent storage devices each comprising one or more processors, a memory, and a storage medium configured to store source data; and one or more application hosts each comprising one or more processors and a memory, communicatively coupled to said one or more intelligent storage devices and configured to generate an execution plan, comprising at least one data filtering parameter, to divide said execution plan into one or more fragments comprising said at least one data filtering parameter, and to provide said one or more fragment to said one or more intelligent storage devices, wherein said intelligent storage device is configured to execute said execution plan fragment on the source data to generate result data selected from the source data based on said at least one data filtering parameter.

According to another aspect of the present invention, there is provided a method of retrieving data from an intelligent data storage system, comprising: transmitting a data request from an application host to an intelligent storage device having one or more processors, a memory, and a storage medium configured to store source data, wherein the application host is configured to generate an execution plan, comprising at least one data filtering parameter, to divide the execution plan into one or more fragments comprising the at least one data filtering parameter, and to provide the one or more fragment to the intelligent storage device; copying source data from the one or more intelligent storage devices into the memory of the intelligent storage device; generating result data by applying the data filtering parameter to the copied source data; and transmitting the result data to the application host.

### BRIEF DESCRIPTION OF THE DRAWINGS

Embodiments of the present invention will be described in conjunction with the accompanying drawings, in which:

FIG. 1 is a schematic block diagram of an attached intelligent data storage system according to one embodiment of the present invention;

FIG. 2 is schematic block diagram of a networked intelligent data storage system according to one embodiment of the present invention;

FIG. 3 is a high-level flowchart illustrating one embodiment of the present invention in which stored data is intelligently retrieved;

FIG. 4 is a flowchart illustrating one embodiment of the present invention in which stored data is intelligently retrieved;

FIG. 5 is a block diagram of an attached intelligent data storage system for a single application host according to one embodiment of the present invention;

FIG. 6 is a block diagram of a plurality of attached intelligent data storage systems for two application hosts according to one embodiment of the present invention; and

FIG. 7 is a block diagram of a plurality of networked intelligent data storage coupled to a plurality of application hosts according to one embodiment of the present invention.

### DETAILED DESCRIPTION

Embodiments of the present invention are directed to an intelligent storage system in which an application host requests data from an intelligent storage device. The application host compiles a search request into an execution plan with one or more filtering parameters. As will be apparent to a person having skill in the art, for example in a database system, the compiler will generate an optimal plan. Such a plan would include fragments that perform filtering at the intelligent storage level. As used herein, filtering parameters include search or filter operators which may be applied to stored source data in order to select or manipulate the source data. After the execution plan is generated, it is divided into one or more fragments so that a fragment may be transmitted to, and executed by, the intelligent storage device. The intelligent storage device uses processors that are local to the intelligent storage device in order to copy into local memory source data from data files that are stored on local storage mediums. The local storage medium may be a magnetic hard disk, but may also be other types of storage medium, such as optical drives. The local processors in the intelligent storage device manipulate the data copied into local memory according to the execution plan fragment, for example, by applying the filtering parameters in the fragment to the copied data, in order to generate result data that is returned to the application host. Since the returned result data is a filtered or selected subset of the source data, the result data is typically smaller in data size than the source data. In many cases, the size of the result data is many orders of magnitude smaller than the size of the source data. There are a variety of benefits which may be obtained by returning smaller size result data to the application host. In one embodiment of the present invention, phenomena such as memory thrashing may be reduced or substantially eliminated. In another embodiment of the present invention, wait times for result data may be reduced, or massively parallel processing may be enhanced. In yet further embodiments of the present invention, data transfer costs may be reduced. Other embodiments of the present invention may provide benefits for these and other problems traditionally associated with transferring and processing large amounts of result data from search requests over networks and/or other communication links.

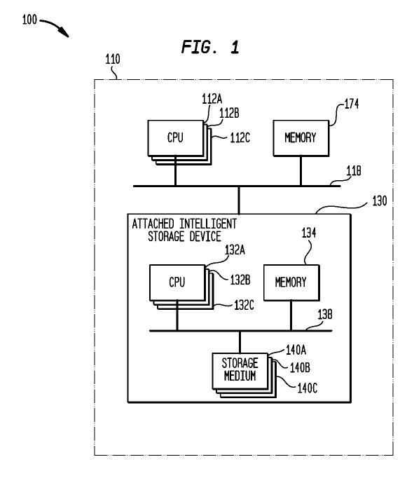

FIG. 1 is a schematic block diagram of an intelligent data storage system 100 according to one embodiment of the present invention. Intelligent data storage system 100 comprises application host 110 which comprises one or more processors 112A-112C (also known as CPUs), collectively referred to herein as processor 112, memory 174, an intelligent storage device 130, and a communication link, depicted in FIG. 1 as a bus 118. Where processor 112 comprises multiple processors in a massively parallel processing (MPP) environment, an inter-process communication (IPC) network (not shown in FIG. 1) may communicatively couple the multiple processors 112A-112C to each other, in order to facilitate communication between the processors, to permit and manage the sharing of resources, to synchronize operations and processing by and between each of the multiple processors, and to permit the performing of various other tasks, as will be apparent those of ordinary skill in the art. It should be understood that although application host 110 is depicted as comprising various computer components such as processor 112, memory 174 and intelligent storage device 130, application host 110 refers also to a virtual system instantiated or created by the execution of software or applications on those and other components. The same is true for storage manager objects, described in detail below, in that storage manager objects should be understood as virtual objects which are instantiated by the execution of software which is designed to provide routines or processes for managing performing data storage functions.

Intelligent storage device 130 is attached to application host 110 in that it shares physical resources with processors 112 of application host device 110. Attached intelligent storage device 130 has one or more processors 132A-132C, memory 134, one or more storage mediums 140A-140C, collectively referred to herein as storage medium 140, and a communication link depicted in FIG. 1 as bus 138.

A search request from a search program or a software application is processed by processor 112. As used herein, a search request is a request for result data that is generated from an information set or source data, such as a database or a text file. In one embodiment of the present invention, the search request typically has at least one filtering parameter, which is applied to the source data in order to select a portion of the source data, or to manipulate or eliminate source data which has been copied into memory 134 of attached intelligent storage device 130. Processor 112 compiles the search request to generate an execution plan. The execution plan may comprise one or more portions which may be executable by the attached intelligent storage device 130. These portions are divided by processor 112 into one or more fragments. A fragment may contain one or more sets of instructions which are executed by intelligent storage device 130. The fragment may also include one or more filtering parameters, such as a text-search operator, or a database predicate or operator such as a SELECT or JOIN operator For example, in one embodiment of the present invention in which the source data is a database system, the execution plan may include a filtering parameter which requires data for all employees in a table “EMPLOYEE PAY” whose salary is $100,000 or greater, where that table is stored in storage medium 140A. Once this filtering parameter is included with one of the several fragments generated, the fragment is transmitted from processor 112 to attached intelligent storage device 130 for execution. In other embodiments of the present invention in which the intelligent storage system is implemented in a multi-processor environment, each of the fragments may be transmitted and executed in parallel fashion by one or multiple processors 112A-112C, referred to herein as processors 112, as will be apparent to one having ordinary skill in the art. One processor of processors 112 may also control a software storage manager object (not shown), which is a software object configured to receive data requests from processors 112 and to assume high level responsibility for storing and/or retrieving data to and from the storage devices. The storage manager object may be configured to manage data storage and/or retrieval from locally attached storage devices such as attached intelligent storage device 130 or networked intelligent storage devices (not shown in FIG. 1).

FIG. 1 further illustrates communication link 118 as a bus 118, to which processors 112, memory 174 and attached intelligent storage device 130 are communicatively coupled, thereby being communicatively coupled to each other. Bus 138 is also configured to operate in a similar manner with respect to the components connected to it within attached intelligent storage device 130. However, it is to be understood that bus 118 and bus 138 may be any type of communication link which permits the components connected to and by each to transmit and receive communication signals. Furthermore, although not depicted in FIG. 1, it is to be understood that various hardware and/or software are implemented in conjunction with the communication links which control, synchronize and otherwise permit signals to be transmitted over the communication links. In certain embodiments of the present invention, it is to be understood that memory 174 may comprise primary memory (e.g., non-volatile RAM) which permits faster transfer of data to and from the primary memory than more permanent memory. Furthermore, it is to be understood that memory 174 may also comprise secondary memory (e.g., magnetic disk) which has a larger storage capacity than memory which may permit faster access. In embodiments of the present invention, memory 174 may comprise both primary and secondary memory.

Traditionally, a search request requiring data from a storage device would simply retrieve the entire data file to be searched. For example, where a database table of a relational database system having 300,000 records or rows of data is being queried, the entire table with its 300,000 records or rows of data would be retrieved from the database file and copied into the primary memory (eg., RAM) of the application host. Where those 300,000 records or rows of data take up a significant portion of the available primary memory, it may be necessary to move the data stored in the memory from the primary memory to secondary memory (e.g., magnetic hard disk). Eventually, when the data that was moved from the primary memory into the secondary memory is required again, or when the data from the database table is determined to no longer be needed in the primary memory, the moved data is once again moved, this time back into the primary memory. Such cyclical moving of data from primary memory to secondary memory and back again, known as memory thrashing, may significantly slow down the operation of the processor and/or the application host, due to the slowness of secondary memory when compared to the primary memory, among other reasons. Although memory thrashing has been described above in a simplified manner, the details and specific drawbacks, causes and side effects of memory thrashing and other phenomena associated with transferring large amounts of data are known to persons having ordinary skill in the art.

In one embodiment of the present invention, an execution plan fragment containing a filtering parameter is transmitted to attached intelligent storage device 130. Rather than simply locating and copying one or more source data files in their entirety into memory 174 of application host 110, attached intelligent storage device 130 executes the search request within attached intelligent storage device 130 and returns only the result data (not shown in FIG. 1) to processor 112 of application host 110. Processor 132 of attached intelligent storage device 130 processes the execution plan fragment to identify and retrieve data from the source data. In one embodiment of the present invention, the entire data file to which the filtering parameter is directed is copied into memory 134 of attached intelligent storage device 130. Processors 132 apply the filtering parameter to the copied data in memory 134 to generate result data, which is then transmitted to processor 112 of application host 110.

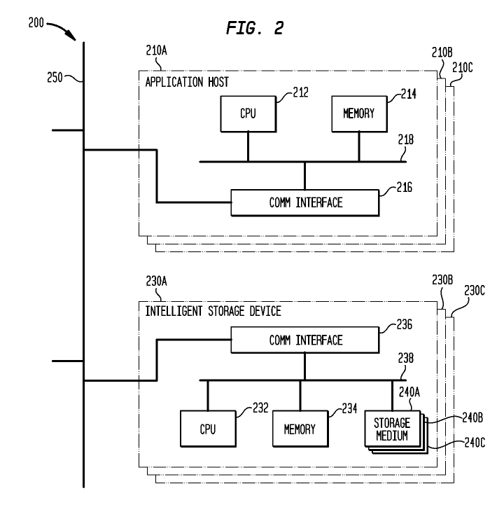

FIG. 2 is schematic block diagram of one embodiment of the intelligent data storage system 100 illustrated in FIG. 1, referred to herein as networked intelligent data storage system 200. FIG. 2 depicts multiple application hosts 210A-210C, each communicatively coupled to each other via an IPC network (not shown), as described previously. Application hosts 210A-210C are each communicatively coupled to a plurality of intelligent storage devices 230A-230C via a communication link 250. Application host 210A-210C and intelligent storage devices 230A-230C each comprise a communication interface 216 and 236, respectively, for facilitation the communication of signals to and from communication link 250. As is known to persons having skill in the art, a cable may be used to connect a connector (not shown) on communication interface 116 to a network device (not shown) such as a router or switch, to connect application host 110 to a LAN or WAN.

Similar to the operation of the embodiment described in conjunction with FIG. 1, application host 210A may compile or process a search request into an execution plan. The execution play may be divided into one or more fragments, one or more of which may contain a filtering parameter. The processor 212, utilizing stored data about the contents and other information pertaining to the source data files or database files being stored on each of storage medium 240A-240C may transmit one or more fragments to one or more intelligent storage devices 230A-230C so that the fragment may be executed in order to generate result data, as described above. Since the result data is generated from the source data by applying filtering parameters to the data in order to select a subset of the source data, the generated result data may be significantly smaller than the source data.

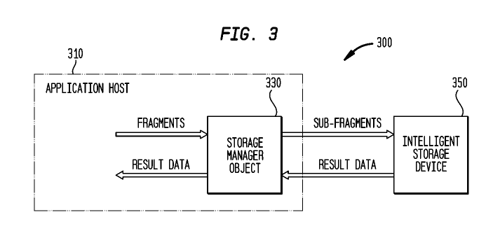

FIG. 3 is a high-level flowchart of one embodiment of the intelligent data storage system 100 illustrated in FIG. 1, referred to herein as intelligent data storage system 300. FIG. 3 depicts an embodiment having multiple intelligent storage devices 350 communicatively coupled to processors (not shown) of application host 310 and software storage manager object 330, described above with respect to FIG. 2. Application host 310 transmits a query fragment, including one or more filtering algorithms, to storage manager object 330. Storage manager object 330 determines which of the multiple intelligent storage devices 350 to transmit one of the one or more fragments to, based on the contents of intelligent storage device 350, and transmits the chosen fragments, referred to in FIG. 3 as “sub-fragments”, to intelligent storage device 350. Where there are multiple intelligent storage devices 350, storage manager object 330 may determine that only a portion of the fragments received from application host 310 should be transmitted to a given intelligent storage device 350, with the rest being sent to one or a variety of other intelligent storage devices for execution. Device 350 executes the fragment, by copying the source data files into its memory, and then selecting, manipulating and/or filtering the source data file in order to generate result data. As shown in FIG. 3, the result data, which is significantly smaller than the source data, is ultimately returned to application host 310. Application host 310 may then apply further filtering operations to the result data.

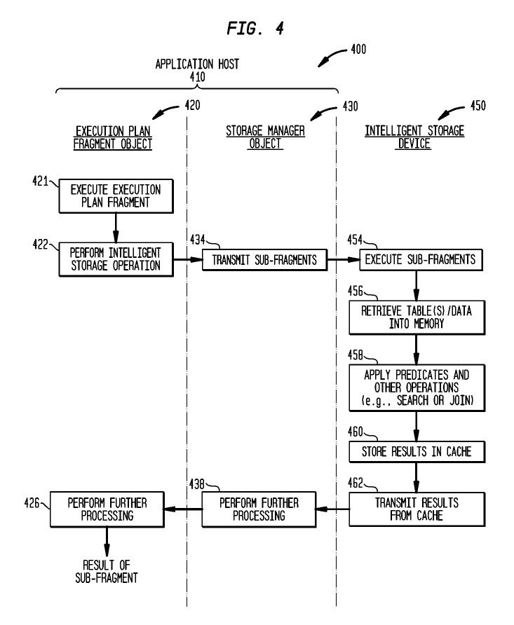

FIG. 4 is a flowchart of one embodiment of the intelligent data storage system 100 illustrated in FIG. 1, referred to herein as intelligent data storage system 400. FIG. 4 depicts various steps taken by application host 410, storage manager object 430 and intelligent storage device 450. It is to be understood that the various steps depicted in FIG. 4 are a simplified representation of the steps which may be taken in order to implement the present invention. As will be apparent to persons having ordinary skill in the art, many steps in addition to those depicted in FIG. 4 are critical or beneficial to the proper execution of the steps described. In FIG. 4, a query or search request is received or generated 412 by application host 410. The query or search request is compiled or otherwise processed 414 by the processors of application host 410 so that the various computer components, that are communicatively coupled to application host 410 and which eventually receives data requests from application host 410, executes the data request. The compiled query or search request is optimized 416, in order to make the execution of the query or search request more efficient or effective, among other optimization functions. Application host 410 generates 418 an execution plan based on the compiled and optimized query or search result. As will be apparent to persons having skill in the art, an execution plan may be viewed as a graph of nodes, which may be operators (e.g., SQL operators) and arcs defining the data flow between those nodes. In some environments, the execution plan is executed as one unit. Alternatively, especially in massively parallel processing (MPP) platforms or computing environments, the execution plan is divided 420 into execution plan fragments. The fragments may then be executed in parallel on different processors of the MPP, in order to speed up the overall query or search request response time. Typically a plan fragment accesses source data from the source database via a storage manager object 430. As shown, the storage manager object 430 may transmit 434 portions of the fragment, or sub-fragments, to an intelligent storage device 450 in one embodiment of the present invention.

A fragment transmitted to intelligent data storage device 450 typically includes filtering parameters such as predicates (e.g., return all rows from the EMPLOYEE table that are making more than $100,000 per year), database operators such as SELECT and JOIN (e.g., return all employees from the EMPLOYEE and PAYROLL tables who are making more than $50K AND who are males), in addition to others, as will be apparent to persons having skill in the art. Upon receiving 454 the fragment or sub-fragment, intelligent storage device 450 retrieves the source data files from the one or more storage medium that are in the intelligent storage device 450. During execution 454 of the fragment, the source data is retrieved from the storage medium in intelligent storage device 450, and the filtering parameters and other operations are applied 458 to the retrieved data to generate result data. The result data is generated and stored 460 in memory 134 of the intelligent storage device 450. Additionally, the result data may be stored memory 174 of application host 110. The result data is stored in memory 134 or 174 in case the same query or search request is made, in which case the result data corresponding to that query of search request is immediately available for access without having to perform the various steps, as described above, associated with executing that query or search request. Intelligent storage device 450 transmits 462 the result data to storage manager object 430 or directly to the processors of application host 410. Unlike traditional systems, embodiments of the present invention minimize the volume of data transferred by intelligent storage device 450 to application host 410 by applying the filtering parameters to the source data stored within intelligent storage device 450, using memory 134 and processors 132 within intelligent storage device 450, to generate result data that is typically drastically smaller in data size compared to the data size of the source data. In certain embodiments of the present invention, storage manager object 430 may be configured to further apply 435 filtering parameters or manipulate the received result data. This may be particularly useful when multiple intelligent storage devices 450 or traditional non-intelligent storage devices are managed by storage manager object 430. In such a case, after storage manager object 430 further applies filtering parameters to the received data to generate its own result data in memory 437, the result data is transmitted 438 to application host 410. Much like the storage manager object's further application of filtering parameters, application host 410 may also apply 426 filtering parameters to the received result data, especially in situations where it receives result data and other data from other devices communicatively coupled to application host 410.

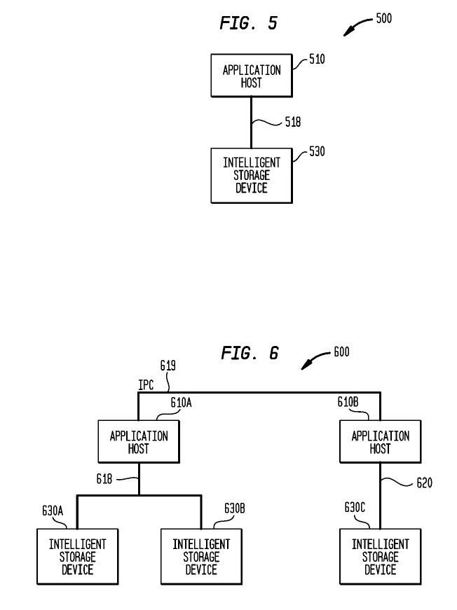

FIG. 5 is a block diagram of one embodiment of the intelligent data storage system 100 illustrated in FIG. 1, referred to herein as intelligent data storage system 500. FIG. 5 depicts a single application host 510 communicatively coupled to a single intelligent storage device 530 over a communication link 518. Intelligent storage device 530 may be an attached intelligent storage device as depicted in FIG. 1 as device 130. Alternatively, intelligent storage device 530 may be a networked intelligent storage device, in which case communication link 518 may be a network connection over, for example, a local area network (LAN), wide area network (WAN). Alternatively, it is to be understood that application host 510 may comprise one or more processors, which may be communicatively coupled via a communication link which allows IPC signals to be passed between the multiple processors.

FIG. 6 is a block diagram of one embodiment of the intelligent data storage system 100 illustrated in FIG. 1, referred to herein as intelligent data storage system 600. FIG. 6 depicts two application hosts 610A and 610B, each having one or more intelligent storage devices 630A-630C according to one embodiment of the present invention. Application hosts 610A and 610B are communicatively coupled to intelligent storage devices 630A-630C via communication links 618. As noted previously, communication links 618 may connect intelligent storage device 630 directly to the processors of application host 610, where intelligent storage device 630 would be considered an attached intelligent storage device 630. Alternatively, communication link 618 may be a network link, in which case intelligent storage device 630 would be a networked intelligent storage device 630. As depicted, IPC link 619 provides a path for the processors of application host 610A and application host 610B to pass IPC communication signals between them Application hosts 610A and 610B are also communicatively coupled via network link 650. Although network link 650 and IPC link 619 are depicted separately in FIG. 6, it should be understood that the two may be implemented using the same physical connection while logically separated through communication protocols, as will be apparent to persons having skill in the art. In the exemplary embodiment of the present invention depicted in FIG. 6, application host 610A may be processing a query or search request, as described previously in conjunction with FIG. 4, which requires source data from intelligent storage device 630A, 630B and 630C. In that case, application host 610A may request result data from application host 610B, depending on the query or search request and the generated execution plan. Upon receiving the request from application host 610A, application host 610B requests the result data from intelligent storage device 630C. Intelligent storage device 630C generates result data in a manner as described above. The result data from intelligent storage device 630C, as noted above, is typically substantially smaller than the source data stored on device 630C from which the result data was generated.

While application host 610B is generating the result data to return to application host 610A, application host 610A continues to process the query or search request by transmitting fragments to each of intelligent storage devices 630A and 630B. Devices 630A and 630B executes the fragment, as described above, to generate result data that is transmitted back to application host 610A. In some cases, each of application hosts 630A and 630B may have filtering parameters such as predicates or database operators in the fragments to be executed such that the result data from each is typically substantially smaller than the source data used to generate the result data. However, in other cases, one or both of intelligent storage devices 630A and 630B may received fragments which simply request result data that is a copy of the entire source data, perhaps due to the filtering parameter requiring result data from other intelligent storage devices together with the result data from either device 630A or 630B.

In this exemplary scenario according to one embodiment of the present invention, once application host 610A receives result data from each of intelligent storage devices 630A and 630B and from device 630C via application host 610B, application host 610A my further apply filtering parameters and other query or search request operations to the received result data.

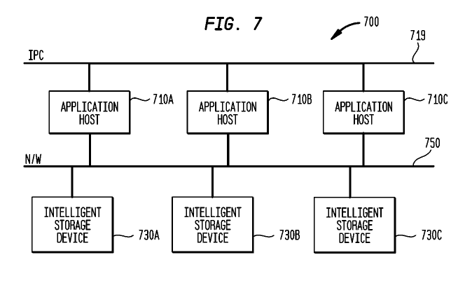

FIG. 7 is a block diagram of one embodiment of the intelligent data storage system 200 illustrated in FIG. 2, referred to herein as intelligent data storage system 700. FIG. 7 depicts a plurality of application hosts 710A-710C communicatively coupled to a plurality of intelligent storage devices 730A-730C according to one embodiment of the present invention. As noted above with regard to individual application hosts, each of application hosts 710A-710C may comprise multiple processors in a massively parallel processing (MPP) environment. As shown, IPC link 719 provides a communication link for IPC signals between the processors of application hosts 710A-710C. Furthermore, application hosts 710A-710C are communicatively coupled to each other and to the plurality of intelligent storage devices 730A-730C over network link 750. As noted above with respect to IPC link 619 and network link 650, IPC link 719 and network link 750 may be physically implemented over the same physical network but separated logically using various network protocols and operating system configurations, as will be apparent to persons having skill in the art.

Each of application hosts 710A-710C have direct access via network link 750 to each of intelligent storage devices 730A-730C. Accordingly, each of application hosts 710A-710C may transmit fragments for a query or search request to one or more of intelligent storage devices 730A-730C. As described above with respect to application host 610A requesting and subsequently receiving result data from multiple intelligent storage devices 630A-630C, each of application hosts 710A-710C may receive result data from various intelligent storage devices and then further apply filtering parameters or other operations to the received result data.

As described above, since the size of the result data returned to application host 710 is typically smaller than the size of the source data from which the result data was generated, embodiments of the present invention are able to reduce or eliminate harmful phenomena such as memory thrashing, as well as enabling or improving parallel or distributed processing in massively parallel processing environment, in addition to other beneficial aspects of the present invention as described above or as will be apparent based on the above to persons having skill in the art.

Although various search request types have been described above, it should be understood that other search request types other than, for example, database or text search requests may be requested in other embodiments of the present invention. Furthermore, it should be understood that other variations in software, hardware, configurations thereof and implementation details and techniques, and their equivalents, now known or later developed, may be used in other embodiments and are considered to be a part of the present invention.

What is claimed is:

1. An intelligent data storage system, comprising:
one or more intelligent storage devices each comprising one or more processors, a memory, and a storage medium configured to store source data; and
one or more application hosts each comprising one or more processors and a memory, communicatively coupled to said one or more intelligent storage devices and configured to generate an execution plan, comprising at least one data filtering parameter, to divide said execution plan into one or more fragments comprising said at least one data filtering parameter, and to provide said one or more fragment to said one or more intelligent storage devices,
wherein said intelligent storage device is configured to execute said execution plan fragment on the source data to generate result data selected from the source data based on said at least one data filtering parameter.

2. The system of claim 1, wherein said one or more processors of said one or more application hosts are communicatively coupled to each other over an inter-process communication (IPC) network.

3. The system of claim 1, wherein said one or more application hosts communicatively coupled to said one or more intelligent storage devices are communicatively coupled over a network.

4. The system of claim 1, further comprising a storage manager communicatively coupled to one or more of said application hosts and said one or more intelligent storage devices, configured to receive said one or more fragments from said application hosts and to transmit at least a fragment to at least one of said intelligent storage devices, and further configured to receive said result data from said at least one of said intelligent storage devices.

5. The system of claim 4, wherein said storage manager is a software object.

6. The system of claim 1, wherein said network comprises a wide area network.

7. The system of claim 2, wherein said network comprises a storage area network.

8. The system of claim 1, wherein said data filtering parameter is a search term for a text search.

9. The system of claim 1, wherein said data filtering parameter is a relational database search predicate.

10. The system of claim 1, wherein said data filtering parameter comprises a JOIN database operator.

11. The system of claim 1, wherein said data filtering parameter comprises a SELECT database operator.

12. The system of claim 1, wherein said intelligent storage device is configured to return said result to said application host.

13. The intelligent data storage system of claim 1, wherein said one or more processors of said application host is configured to determine which of said one or more intelligent storage devices to transmit said execution plan fragment comprising said at least one data filtering parameter to, based on said data filtering parameter.

14. The intelligent data storage system of claim 1, wherein said intelligent storage device comprises a plurality of storage mediums.

15. A method of retrieving data from an intelligent data storage system, comprising:
transmitting a data request from an application host to an intelligent storage device having one or more processors, a memory, and a storage medium configured to store source data, wherein the application host is configured to generate an execution plan, comprising at least one data filtering parameter, to divide the execution plan into one or more fragments comprising the at least one data filtering parameter, and to provide the one or more fragment to the intelligent storage device;
copying source data from the one or more intelligent storage devices into the memory of the intelligent storage device;
generating result data by applying the data filtering parameter to the copied source data; and
transmitting the result data to the application host.

16. The method of claim 15, further comprising:
determining which of said one or more intelligent storage devices to transmit said execution plan fragment comprising said at least one data filtering parameter to, based on said data filtering parameter.

17. The method of claim 15, further comprising:
transmitting a data request from the application host to a second application host; and
receiving result data from said second application host.

18. A computer readable medium, having a program recorded thereon, where the program is configured to make a computer execute a procedure to implement an intelligent data storage system, said procedure comprising the steps of:
transmitting a data request from an application host to an intelligent storage device having one or more processors, a memory, and a storage medium configured to store source data, wherein the application host is configured to generate an execution plan, comprising at least one data filtering parameter, to divide the execution plan into one or more fragments comprising the at least one data filtering parameter, and to provide the one or more fragment to the intelligent storage device;
copying source data from the one or more intelligent storage devices into the memory of the intelligent storage device;
generating result data by applying the data filtering parameter to the copied source data; and
transmitting the result data to the application host.

19. The computer readable medium of claim 18, further comprising:
determining which of said one or more intelligent storage devices to transmit said execution plan fragment comprising said at least one data filtering parameter to, based on said data filtering parameter.

20. The computer readable medium of claim 18, further comprising:
transmitting a data request from the application host to a second application host; and
receiving result data from said second application host.
